(19) United States
(12) Patent Application Publication
(10) Pub. No.: US 2003/0082316 A1
(43) Pub. Date: May 1, 2003

(54) Beard-go-round display device

(76) Inventor: Thomas E. Scott, Greenville, IL (US)

Correspondence Address: DON W. WEBER, 101 WEST VANDALIA, SUITE 325M, EDWARDSVILLE, IL, 62025, US

(21) Appl. No.: 10/007,937

(22) Filed: Oct. 26, 2001

(51) Int. Cl. G09F 19/00

(52) U.S. Cl. 428/16

(57) ABSTRACT

A turkey trophy display device is disclosed providing a way to display a turkey fantail, beards, and spurs. The display has a bottom circular base connected to an upper stationary base by means of dowel support rods. On top of the upper stationary base is a rotating carriage. Securing holes are drilled in the upper rotating carriage so that turkey beards can be fastened to the rotating part of the display. A spring-loaded rod is also affixed between the upper and bottom stationary bases. The rod can be temporarily raised to insert it through the center of the turkey spur. Because the distance between the spring-loaded rods and the support rods is quite close, the turkey spurs remain stationary. The beards may be rotated in a 360-degree circle. An alternative, upper fan display support may also be secured to the stationary upper base. When the upper support is used, the fantail and spurs remain stationary while the beards are allowed to rotate freely. The fantail display support can also be replaced with a lamp and lampshade for decorative purposes.

### BACKGROUND OF THE DEVICE

This invention relates to the field of hunting. More particularly, a rotating display device to be used in displaying a turkey fantail, turkey beards, and turkey spurs is disclosed.

In the field of hunting, it is commonly known for a hunter to make trophies of his prey. Common trophies and mounting disciplines include the field of taxidermy and the field of mounting. For example, deer heads are often mounted on plaques to be hung on the wall. Similarly, bears, fish and other animals are often stuffed and then mounted for display. This invention relates generally to the display of the fantail, beard, and spurs of a turkey or other hunting fowl.

Due to the unique nature of the parts of the turkey to be displayed, a specialized type of trophy device is required. Previous attempts at creating trophy displays for turkeys are known in the prior art. For example, the 1991 patent issued to Acker (U.S. Pat. No. 5,064,725) is a Turkey Trophy Mounting Kit. Acker involves a plaque that is capable of displaying the turkey fantail, turkey beard and turkey feet. One drawback of the Acker device is that the display is quite immobile and does not allow for the full viewing of certain attractive parts of the turkey trophy.

Another game bird feather mount is found in the 1995 patent issued to Fredeen. This feather mount (U.S. Pat. No. 5,437,935) is designed to realistically display the feathers of a game bird, such as a wild turkey. Fredeen includes a frame and mounting block with a number of holes for receiving the feathers. However, the Fredeen device does not provide for a means of displaying the turkey feet. It is an object of this invention to provide a display device that is capable of displaying the turkey fantail, beards and spurs from any angle.

One of the drawbacks of many of the prior art game display devices is that they do not allow the observer to view certain parts of the fowl from various angles. It is another object of this invention to allow a hunter to display the fantail and spurs of a turkey from a stationary display, while also allowing the viewer to examine the turkey beards as they are rotated 360 degrees. Other and further objects of this device will become apparent upon reading the below described Specification.

### BRIEF DESCRIPTION OF THE INVENTION

A turkey trophy display device is presented having a circular base connected to an upper rotating carriage by means of a central main support. The bottom base remains stationary while the upper carriage rotates. The upper carriage has an optional fantail display support into which the turkey fantail may be secured. The upper carriage has a number of holes into which the beards of the turkey may be secured by screws. Left and right dowel rods also connect the bottom stationary base to the upper rotating carriage. Spring-loaded mounting rods are adapted to receive the spurs of the turkey. Because of the unique shape of the turkey spur trophy, the stationary and spring-loaded rods keep the turkey spurs in a natural position such that they are displayed rearwardly of the entire device. The upper carriage may be rotated in a 360-degree circle such that the turkey beards may be viewed.

### BRIEF DESCRIPTION OF THE DRAWING FIGURES

FIG. 1 is a perspective view of the device showing the turkey fantail, beard and spurs in their secured position.

FIG. 2 is a front, exploded view of the display device.

FIG. 3 is a partial perspective view of the upper portion of the device, also showing the fantail display supports.

FIG. 4 is a side cutaway view of a portion of the upper rotating carriage, showing the beard securing slots and screws.

FIG. 5 is a partial view of the upper, right hand side of the device, showing particularly the spur stationary rods, the movable spur securing rods, and the securing rod springs.

FIG. 6 is a cutaway view of the spur stationary rods, the movable securing rods, and the turkey spurs, shown with the spur in position.

FIG. 7 is a perspective view of the device similar to that shown in FIG. 1.

FIG. 8 is an alternate embodiment of the device, wherein the fantail display supports are replaced with a lamp and lampshade.

FIG. 9 is a side view of a wall-mounting mechanism.

### DETAILED DESCRIPTION OF THE PREFERRED EMBODIMENT

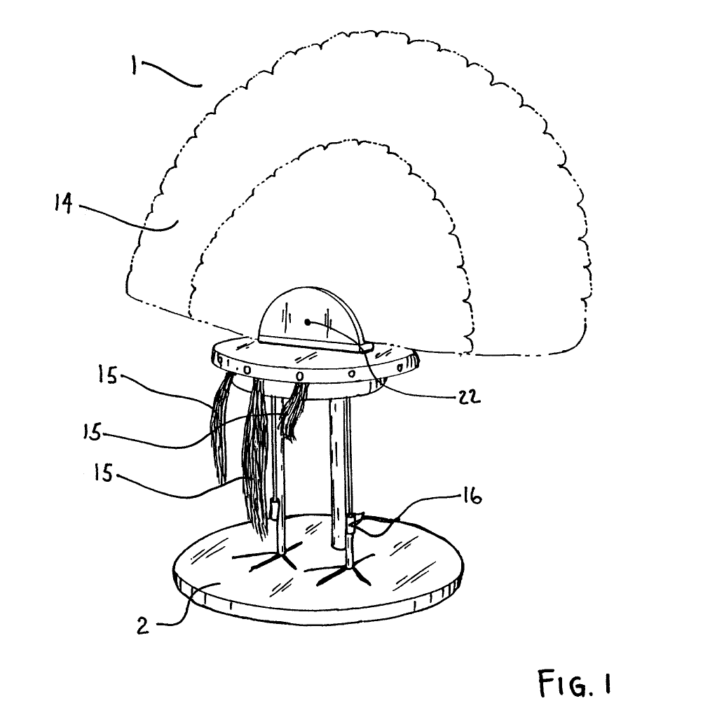

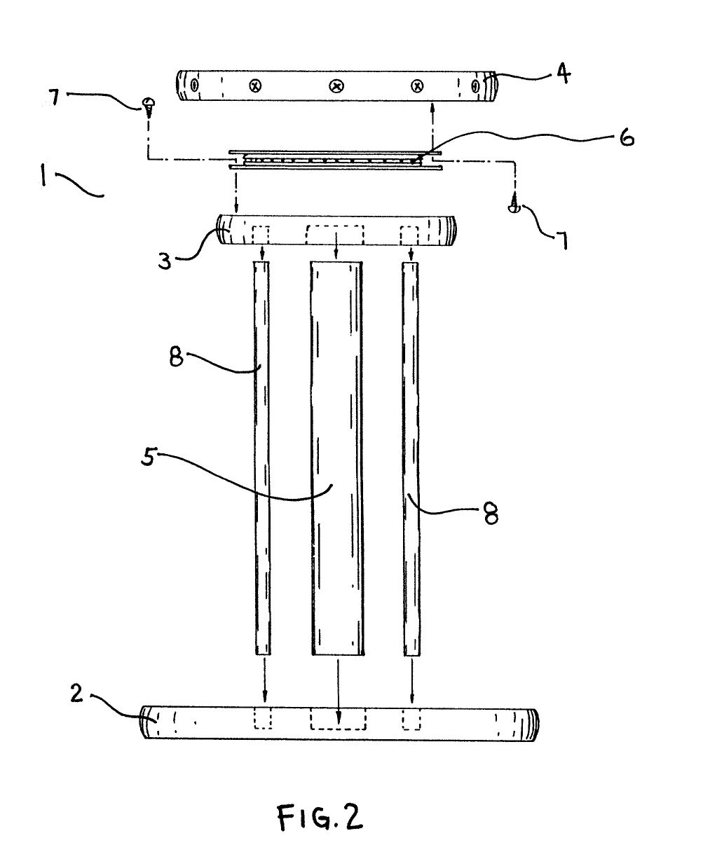

A turkey beard-go-round display device is presented having a stationary lower base and an upper, rotating carriage mounting. The turkey trophy display device 1 is best shown in FIGS. 1, 2 and 7.

The turkey trophy display device has a bottom, stationary base 2. This bottom, stationary base may be of any size or shape. However, the preferred embodiment includes a bottom, stationary base 2 which is in the shape of a disk having a diameter of approximately twelve (12) inches. The base 2 may be decorated.

The upper portion of the display device includes an upper base 3, that is connected to the lower base 2 by means of a sturdy central main support 5. In the preferred embodiment, the upper stationary base 3 is a disk having a diameter of approximately eight (8) inches. The upper stationary base 3 is connected to the bottom stationary base 2 by means of a central main support dowel rod 5 in the preferred embodiment. While this dowel rod may be made of wood, plastic or metal, and while it may be cylindrical, square, or have other geometric shape, the preferred embodiment comprises a cylindrical dowel rod 5 which has an approximate diameter of ¾ inches and an approximate length often (10) inches.

Located on top of the upper stationary base 3 is a turntable 6. This turntable is permanently attached to the upper stationary base 3 and also to the upper rotating carriage 4 by means of carriage-upper base securing screws 7.

The upper rotating carriage 4 is also a disk in the preferred embodiment. The approximate size of the upper rotating carriage 4 is a disk having a diameter of approximately ten (10) inches. The bottom base 2 and upper base 3 are stationary and remain in the same orientation when placed on a table, shelf, or other surface. However, because of the turntable 6, the upper rotating carriage 4 may rotate in a 360-degree circle.

Spur stationary rods 8 are also connected between the bottom 2 and upper 3 stationary bases. The stationary rods 8, as well as the central main support 5, are connected to the bottom 2 and upper 3 stationary bases by any convenient means, such as countersinking holes and gluing the rods to the bases. While this method is preferred, it is to be understood that any method of connecting the stationary rods 8 and central main support 5 to the upper and bottom bases is well within the spirit and concept of this invention.

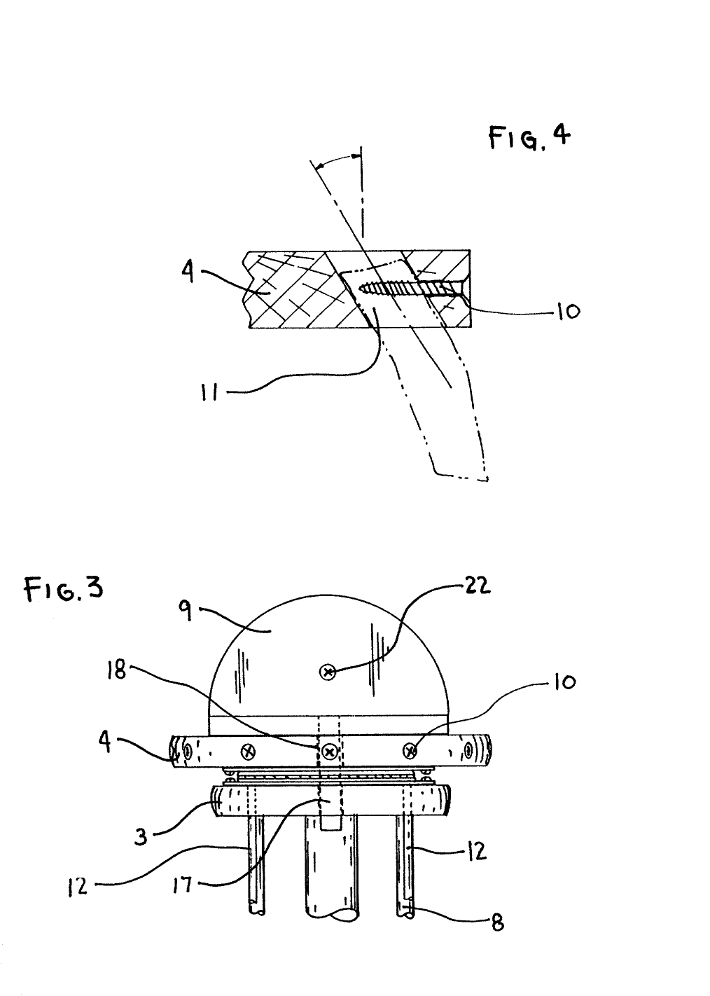

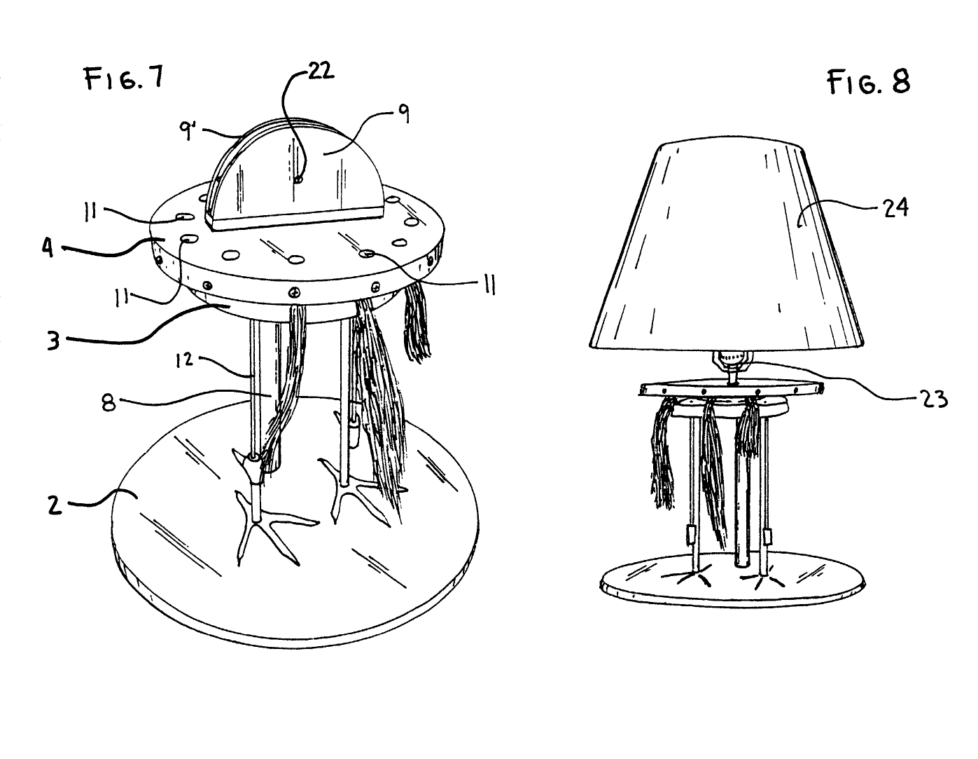

Turning now to FIG. 3, the upper portion of the preferred embodiment of this invention is shown. The upper rotating carriage 4 has a series of slots 11 drilled near the edge of the disk. These slots are adapted to receive the beards of the turkey, as best shown in FIGS. 1 and 7. The slots 11 are drilled at an approximately 30-degree angle, as shown in FIG. 4. A corresponding set of holes are also drilled perpendicular to the axis of rotation of the disk to allow for the insertion of beard securing screws 10 as shown in FIG. 4. The plurality of evenly spaced beard securing slots 11 are drilled throughout the upper rotating carriage 4, as best shown in FIGS. 3 and 7. These beard securing slots 11 allow the hunter to mount any desired number of beards at any desired location so as to enhance the aesthetic quality of the turkey display device.

As best shown on FIGS. 3 and 7, front 9 and back 9′ fantail display supports may also be attached to the device on top of the rotating carriage 4. The preferred embodiment for the fantail display supports 9 and 9′ is that of a semi-circle, having an approximate radius of three (3) inches. The fantail display supports 9 and 9′ are attached to the upper stationary base 3 by means of a fantail display support peg 17. This peg 17 connects the uppermost fantail display supports 9 and 9′ to the stationary upper base 3. The fantail peg 17 is inserted through a hole 18 in the center of the upper rotating carriage 4. This fantail peg hole 18 in the upper rotating carriage 4 is slightly larger than the diameter of the fantail support peg 17. Because the fantail display hole 18 is slightly larger than the fantail support peg 17, the upper rotating carriage 4 can rotate even though the fantail display supports 9 and 9′ remain stationary.

In order to display the turkey spurs, the spur stationary rods 8 and the movable securing rods 12 are utilized. Turkey spurs 16 are irregularly shaped as shown in FIG. 6. The spurs have a central bone 19 that is essentially circular as shown on FIG. 6 However, this central bone 19 has a crescent-shape 20 at one perimeter of the spur 16. In order to prepare the turkey spur 16 for display, the bone marrow is removed from the center of the bone 19.

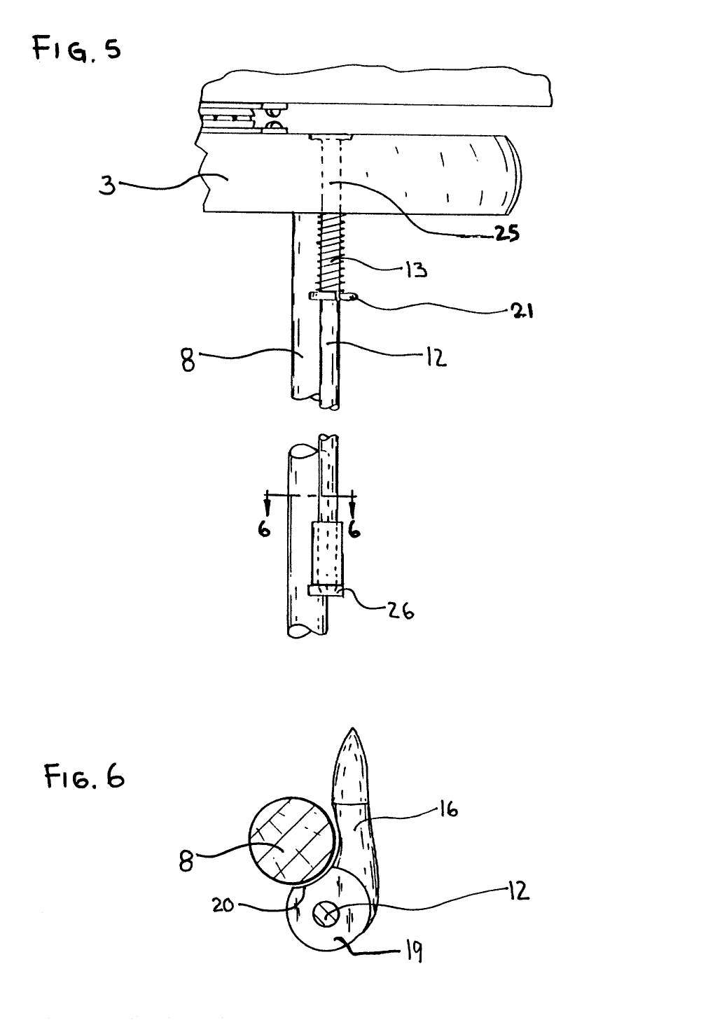

A spring-loaded, movable spur-securing rod 12 is located near each stationary rod 8, as best shown in FIGS. 5 and 6. The stationary rod 8 and the movable spur securing rods 12 are parallel to each other and perpendicular to the bottom 2 and upper 3 stationary bases.

In order to mount the turkey spur 16, the movable securing rod 12 is pushed upwardly in the vertical direction, leaving a small gap between the bottom portion of the securing rod 12 and the securing rod seat 26 attached to stationary rod 8. The turkey spur 16 may then be mounted by sliding the spur-securing rod 12 through the hole in the center of the turkey bone 19. The securing rod 12 is biased downwardly by means of the movable securing rod biasing spring 13, as best shown in FIG. 5. When the movable rod 12 is moved upwardly, it moves into the securing rod hole 25 in the upper base 3. A flange 21 or cotter pin biases the securing rod 12 downwardly onto the securing rod seat 26.

In the preferred embodiment, the center of the central main support 5 is approximately four (4) inches from the center of the spur stationary rods 8. The centers of the spur stationary rods are approximately four (4) inches apart. The main support 5 and rods 8 form an equilateral triangle. The centers of the spur stationary rods 8 and the movable securing rods 12 are approximately ⅜″ apart. The preferred size of the spur stationary rods 8 is approximately ⅜″ diameter. The preferred size of the movable securing rods 12 is approximately 3/16″ diameter The close spacing between the spur stationary rod 8 and the spur movable securing rod 12 allows for the mounting of the spurs such that the spur bone crescent 20 fits snugly against the spur stationary rod 8. This snug fit inhibits the rotating movement of the spur 16 once it is secured onto the display device.

As best shown on FIGS. 1 and 7, the turkey spurs, beards and/or turkey fantails may be mounted upon the device for viewing and display. In order to mount the beards, one end of the beard is inserted into the beard-securing slot 11 as shown on FIG. 4. The beard is then secured to the upper rotating carriage 4 by means of the beard securing screws 10. A number of beards 15 may be secured in any desired fashion due to the plurality of beard securing slots 11 located around the outer circumference of the rotating carriage 4.

A number of turkey spurs 16 may also be mounted and secured in a stationary position as previously described.

The optional fantail display support 9 and 9′ may be used to display the turkey fantail 14. The turkey fantail 14 is simply inserted between the front 9 and back 9′ fantail display supports, as shown in FIGS. 1 and 7. The turkey fantail 14 may then be secured into the fantail display supports 9 and 9′ by a securing screw 22.

Once the turkey fantail, beards, and spurs have been secured to the turkey trophy display device 1, the trophy parts of the turkey may be readily displayed. While the spurs 16 and fantail 14 remain in a stationary position with respect to the viewer, the upper rotating carriage 4 may be turned so as to view the turkey beards 15.

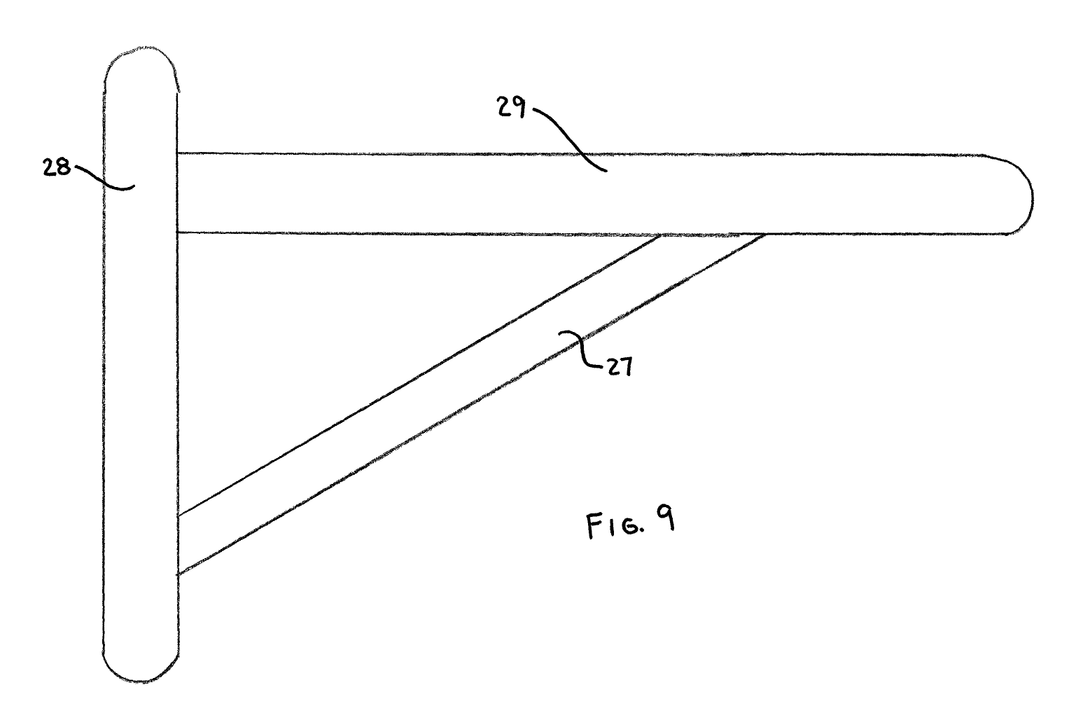

An alternative embodiment of this device is shown in FIG. 8. In this embodiment, the fantail display supports 9 and 9′ are replaced with a light fixture 23 and lampshade 24. In this embodiment, the electrical cord runs down through the upper base 3 and upper rotating carriage 4 to the electrical outlet. The beards 15 may still be rotated while the spurs remain in a fixed position.

As an optional means of displaying this device, the beard-go-round may be mounted onto the wall by means of a large hardwood mounting structure located below and perpendicular to the bottom stationary base 2. An oblique hardwood dowel 27 would also be utilized to connect the perpendicular hardwood support 28 and the horizontal hardwood base 29 to be mounted to the bottom stationary base 2, as shown in FIG. 9. Obviously, alternate means of mounting or displaying the essential turkey trophy display 1 are well within the contemplation and spirit of this device. The device as shown, including the means of mounting the device to the wall, and the embodiment including a light fixture and lamp shade are well within the spirit and disclosure of this Specification.

The dimensions given herein are for means of illustration only, and are included in the preferred embodiment of the device. However, the exact placement of the central main support 5 in relation to the spur stationary rods 8 are meant as a means of illustration only and not as a limitation. Obviously, the main support rod 5 and spur stationary rods 8 may vary in their location depending upon the aesthetic qualities as determined by the practitioner.

While the center distances of the adjacent stationary rods 8 and spring-loaded securing rods 12 is of importance, the precise dimensions are meant as a means of illustration only. As long as the smaller securing rods 12 are close to the stationary rods 8, the turkey spur will be held in a stationary position. Similarly, the number of beard securing slots 11 as well as the angle of those slots and the precise means of securing the beards in the slots, is meant as a means of illustration only. For example, dowel rods could replace the beard securing screws 10 while still keeping within the spirit and disclosure of this invention.

While the preferred embodiment includes a disc shaped bottom base 2, upper base 3, and upper rotating carriage 4, the precise geometric configuration could be varied depending upon the aesthetic attributes sought to be achieved with this display device.

Generally this device is constructed mostly of hardwood and dowel rods, as previously described. In the preferred embodiment, the movable securing rods 12 and securing rod seats 26 are made of brass. However, the entire device could be made of wood or plastic and the brass rods and seats could be made of any suitable material while still keeping within the spirit and disclosure of this invention.

Having fully described my turkey trophy display device, I claim:

1: A turkey trophy display device for displaying a turkey fantail, beards and spurs, comprising:
(a) stationary bottom and upper bases connected to each other by a central main support and stationary rods;
(b) an upper carriage, rotatably secured to the upper base.
wherein said upper carriage has a plurality of beard attaching means; and
(c) spur securing means for securing turkey spurs to the device.

2: A turkey trophy display device as in claim 1, further comprising a fantail display support attached to said upper stationary base.

3: A turkey trophy display device as in claim 1, wherein said beard attaching means comprises an upper carriage having a plurality of slots adapted to receive said beards and screws adapted to secure said beards in said slots.

4: A turkey trophy display device as in claim 1, wherein said spur securing means comprises spring-loaded rods parallel and adjacent to said stationary rods, said spring-loaded rods adapted to be inserted through said turkey spurs.

5: A turkey trophy display device as in claim 1, further comprising a light fixture and lamp shade secured to the top of said device.

6: A turkey trophy display device as in claim 1, further comprising a support means for attaching said turkey trophy device to a wall.
